(19) United States
(12) Patent Application Publication
(10) Pub. No.: US 2004/0059583 A1
(43) Pub. Date: Mar. 25, 2004

(54) Temporary staff order and management system

(76) Inventor: J. Chris O'Neill, Dallas, TX (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/251,528

(22) Filed: Sep. 20, 2002

(51) Int. Cl. G06F 17/60

(52) U.S. Cl. 705/1; 705/11

(57) ABSTRACT

A computer server talent management system facilitates management of temporary staff procurement and administration. The server provides a network based implementation of an improved process that allows workplace managers to initiate the procurement of temporary staff in a familiar manner, such as by calling, emailing or faxing the vendor. The Vendor then uses an interface provided by the server to generate a purchase order based on a workplace company's specific template. The purchase order is then sent to the workplace manager, who uses interfaces provided by the server to approve the purchase order in accordance with rules enforced by the server.

### FIELD OF THE INVENTION

The present invention relates to a network enabled system for the procurement and administration of temporary staff sourced from multiple vendors by a single workplace firm.

### BACKGROUND OF THE INVENTION

Temporary staffing methods and systems have taken many different forms. Typically, large companies employ several staffing vendors, establishing contracts with each vendor for provision of temporary staffing. In operation, a manager at the company will call a contact at the staffing vendor and request temporary staff. After some time, it becomes quite easy to request staff with certain capabilities learned from experience. For instance, a request may take the form of “I want someone like, Kelsey”. Much information is conveyed in this statement if delivered to a vendor with prior experience with Kelsey. However, the same request would not work with a different vendor who does not know or have experience with Kelsey.

With multiple vendors, it is difficult for a company to track the temporary staff being utilized, including where and how they are being used. Assignment end dates may come and go without the temporary staff actually ending their assignment. Further, each staffing vendor submits a separate invoice for each worker often for each workweek, leading to significant back office work on the part of the workplace company to ensure accuracy and proper accounting of costs.

Some computer systems have been developed that attempt to integrate purchasing from multiple staffing vendors. In such systems, the provider of the computer system serves as a middleman or wholesale agent for the workplace firm, gathering requests for temporary staffing, and contacting vendor seeking the best price and/or the best inventory or availability of talent for the request. This method provides some control over costs, and provides some information regarding the amount of temporary staffing being utilized by the company, but also forces the workplace managers to all source through the same provider, regardless as to whether or not he provides the best service for his individual need.

### SUMMARY OF THE INVENTION

A network based computer system referred to as a talent management system (TMS) facilitates the procurement and administration of temporary staff sourced from multiple vendors all of whom serve as a primary vendor. In one embodiment, TMS provides a network based implementation of an improved process that allows workplace managers, with delegated authority to initiate the procurement of temporary staff from pre-approved suppliers using any one of a familiar manner, such as by calling, emailing or faxing the vendor while still providing centralized management with a means for comprehensive reporting and improved back office processes for this expenditure.

The Vendor uses an interface provided by TMS to self-submit for a purchase order based on the workplace firm's specific template for a PO. The purchase order is then made available to the field manager, who uses an interface to complete the purchase order request which is then processed for delegate authority, escalated to a supervisor if necessary and then once approved a PO is processed with approval notification delivered to the vendor and talent.

In further embodiments, the selected temporary staff loaded in the purchase order by the vendor. The temporary staff is provided an interface for time and expense entry that is then routed to appropriate managers for confirmation. Workplace managers are provided interfaces for documenting the performance of the temporary staff.

In still further embodiments, the server further tracks the use of temporary staff and facilitates management of the temporary staff by providing reports and automated notices. Such notices include communications regarding the end date of assignments sent a predetermined time ahead of the end date allowing the workplace manager time to determine whether to request an extension of the term.

### BRIEF DESCRIPTION OF THE DRAWINGS

FIG. 1 is a block diagram of a talent management system in a server driven network environment.

FIG. 2 is a block representation of talent data stored in a database of the talent management system of FIG. 1.

FIG. 3 is a block representation of administrative information stored in the database of the talent management system of FIG. 1.

FIG. 4 is a flow chart describing a process of setting up and utilizing the talent management system of FIG. 1.

FIG. 5 is a screen shot of a staffing vendor menu interface provided by the talent management system of FIG. 1.

FIG. 6 is a screen shot of a staffing vendor purchase order request interface provided by the talent management system of FIG. 1.

FIG. 7 is a screen shot of a staffing vendor discovery interface provided by the talent management system of FIG. 1.

FIG. 8 is a screen shot of a workplace manager interface provided by the talent management system of FIG. 1 to identify locations and jobs.

FIG. 9 is a screen shot of an interface provided by the talent management system of FIG. 1 for entering talent information.

FIG. 10 is a screen shot of an interface provided by the talent management system of FIG. 1 for selecting unapproved purchase orders.

FIG. 11 is a screen shot of a workplace manager interface provided by the talent management system of FIG. 1 for selecting approved vendors.

FIG. 12 is a screen shot of a workplace manager interface provided by the talent management system of FIG. 1 for selecting start logistics information to send to selected talent.

FIG. 13 is a screen shot of an interface provided by the talent management system of FIG. 1 for adding new users.

FIG. 14 is a screen shot of a workplace manager interface provided by the talent management system of FIG. 1 for approving purchase orders.

FIG. 15 is a screen shot of an interface provided by the talent management system of FIG. 1 showing approved purchase orders identifying specific talent.

FIG. 16 is a screen shot of a talent time card entry interface.

FIG. 17 is a screen shot of a further talent time card entry interface.

FIG. 18 is a screen shot of a talent time card submission interface.

### DETAILED DESCRIPTION OF THE INVENTION

The following description and drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full gambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples.

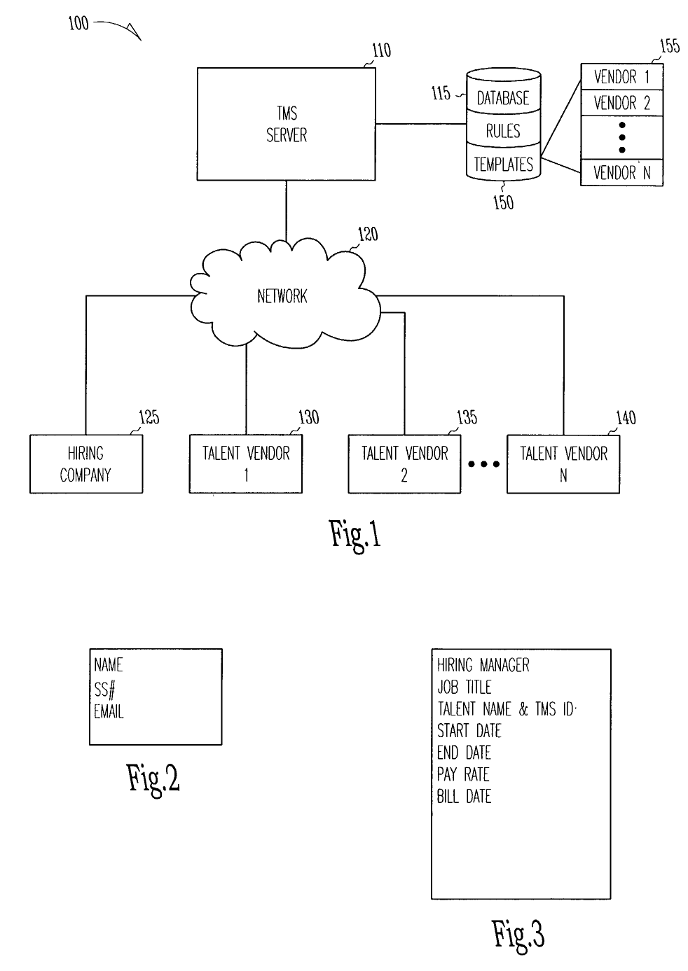

A talent management system is shown generally at 100 in FIG. 1. The talent management system facilitates management of temporary staff procurement and administration. The system comprises a server 110 that is coupled to a database 115 comprising information related to talent vendors, talent and a workplace company. The server 120 is also coupled to a network 120, such as the Internet, or other type of network that provides communications between multiple devices. Also coupled to network 120 are at least one workplace company. Multiple talent vendors 130, 135 and 140 that are also known as temporary staffing agencies are also coupled to network 120. The vendors provide temporary staff or talent to the workplace company.

When a workplace manager at a hiring company desires to obtain temporary staff for a project or other business need, the workplace manager communicates with at least one vendor asking them to fill the need. In many cases, workplace managers are used to working with specific people at vendors and in a specific manner. A phone call is one way in which the workplace manager may communicate a need to a vendor. The workplace manager may be very informal in the description of requirements, such as “I need someone like Stan for a couple months to do some payroll work for me.” Given the prior relationship between the vendor and the workplace or field manager, this is actually a very specific request that the experienced vendors knows how to fulfill. The request may be communicated by email, voice, fax, in person or in any other manner desired.

Once the request is received and the correct talent is interviewed and agreed to by the workplace manager, the vendor signs on to their user account on the workplace webserver 110. The vendor then accesses a template from templates 150 from the database 115. As indicated in an expanded view of templates 150, at 155, templates are provided for different vendors. Further, the templates are specific to each workplace company. The templates describe a purchase order shell by which the vendor can fill in specific information to fulfill the request. Example user interfaces for performing these functions are shown below. As information is entered into the system, many of the fields in the interfaces or screens may be automatically filled in with information existing in the database from prior purchase orders, minimizing the efforts required to create and approve purchase orders.

Rules are also provided in database 115 specifying the relationship between each vendor and a workplace company. The rules relate to agreements for provision of talent, and encapsulate the terms and conditions for procuring and administration of the talent. The rules also relate to the approval process required within the workplace company.

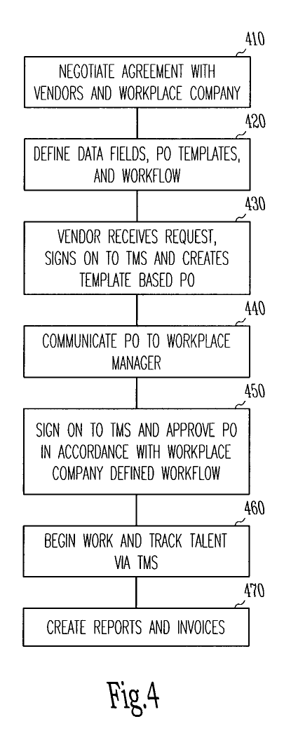

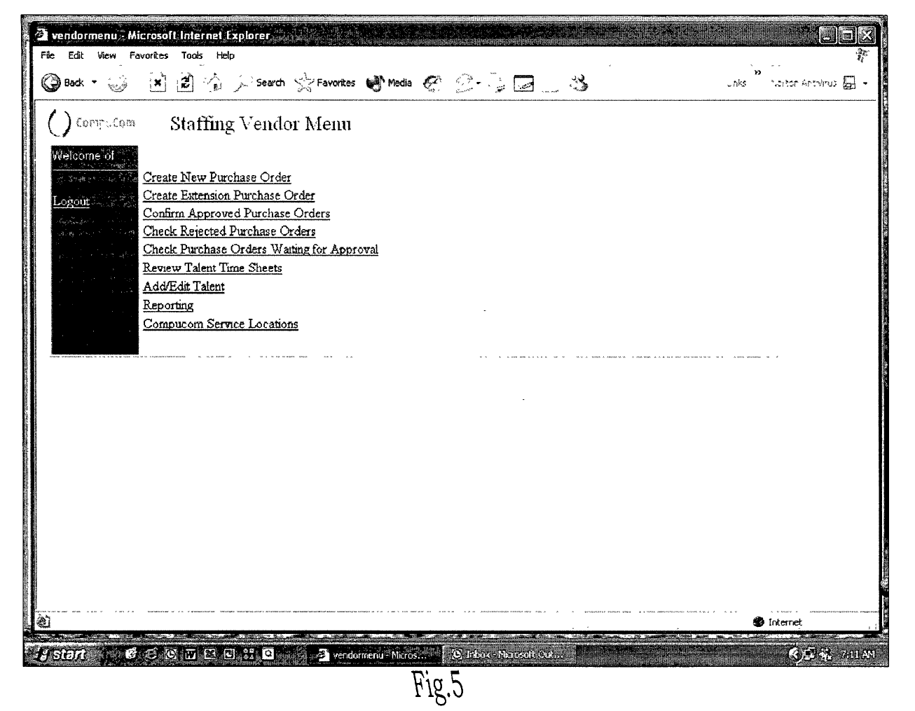

Examples of data collected via multiple interfaces provided by the server to different groups of users is shown in FIG. 2 and FIG. 3. In FIG. 2, talent information is described, including name, social security number and email address. The email address is used to communicate with the talent prior to the start of an assignment to fulfill an approved purchase order. In FIG. 3, the workplace manager is identified, and a job title, talent name and unique ID, start date, end date, pay rate and bill rate are all provided. These fields are also filled in via multiple user interface screens generated by the server and rendered at a user machine such as a personal computer or other network appliance.

An overall process flow chart identifying high level functions performed in setting up and utilizing the talent management system 100 is shown in FIG. 4. A block 410 represents a negotiation of an agreement between one or more vendors and a workplace company. The agreement will define some of the workflow and rules describing how the relationship will work, and how talent will be procured and administered. Once the agreement has been negotiated, it is used to define data fields required, purchase order templates consistent with the agreement and workplace company requirements, and workflow rules for generation and approval of purchase orders at 420.

At 430, the system is ready for use, and a vendor receives a communication of a need for talent at 430. The communication can be in any form now known or conceived in the future. It simply identifies the need in terms of for example, a skill set and location. The vendor receives the request and signs onto the server 110, and uses a screen to pull up a shell purchase order corresponding to the workplace company making the request. The shell purchase order is template based, and specific to the workplace company such that the workplace company receives purchase orders from multiple different vendors that are consistent with their administrative process needs. Once the purchase order is completed, it is communicated to the workplace manager at 440 for approval. The communication may take the form of an email or other communication informing the workplace manager that a purchase order has been created and is ready for his approval.

At 450, after receiving notification of the pending purchase order, the workplace manager signs onto server 110 and views a list of pending purchase orders. The workplace manager then approves the purchase order in accordance with a workplace company defined workflow. In some instances, the workflow may dictate that another person is required to approve the purchase order once the workplace manager approves it. In such a case, the workflow rules cause another communication to be sent to such a person, who then similarly signs on to approve the purchase order.

Once the purchase order is approved, the vendor is notified, and the talent is informed of the assignment location and term. Other relevant information is also provided, such as the manager at the workplace company. Box 450 represents the talent beginning to work. The talent fills reports time, which is compiled by server 110, and the begin and end dates are also tracked in the server.

At 470, reports are created as requested, or automatically generated in accordance with workflow rules. Further invoicing for each vendor is summarized as desired by the workplace, proofed for accuracy and then presented for direct payment to each vendor, In one embodiment, automatic reminders of an approaching end date are sent to designated parties to assist in managing the talent. Having all data related to talent from multiple vendors in a single system provides the ability to manage the procurement and administration of talent much more easily than dealing with each vendor separately.

FIG. 5 is a screen shot of a menu created by the server 110 that identifies functions for a staffing vendor. It allows selection of creating new purchase orders, extending a purchase order, confirming approval of purchase orders, checking rejected purchase orders, checking purchase orders waiting for approval, reviewing talent time sheets, adding or editing talent, reporting, and obtaining a list of service locations. These functions allow the vendor much easier access to information to facilitate following up on purchase orders that are not approved.

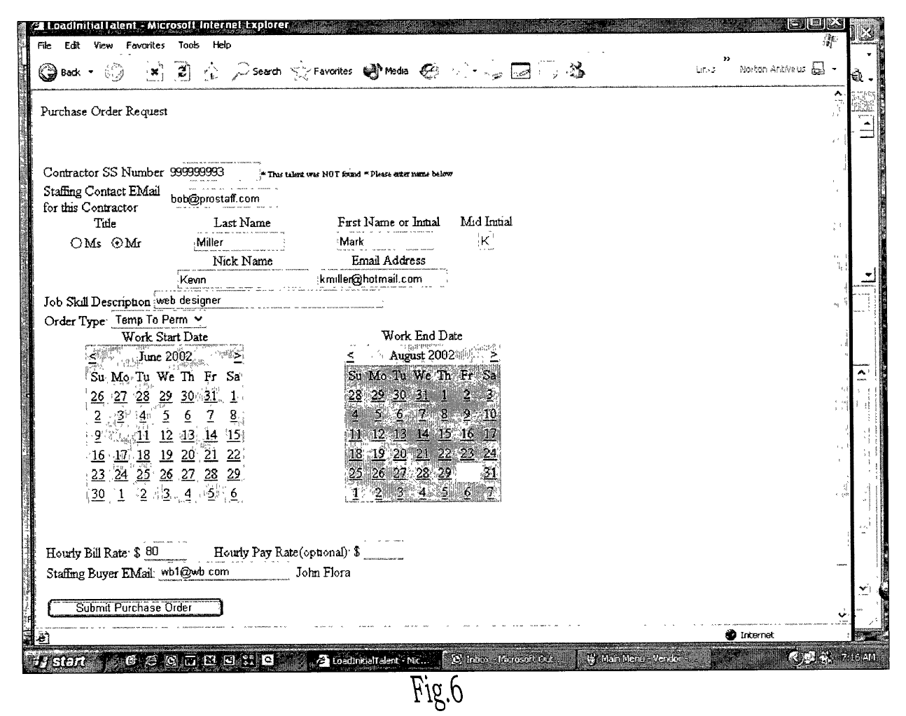

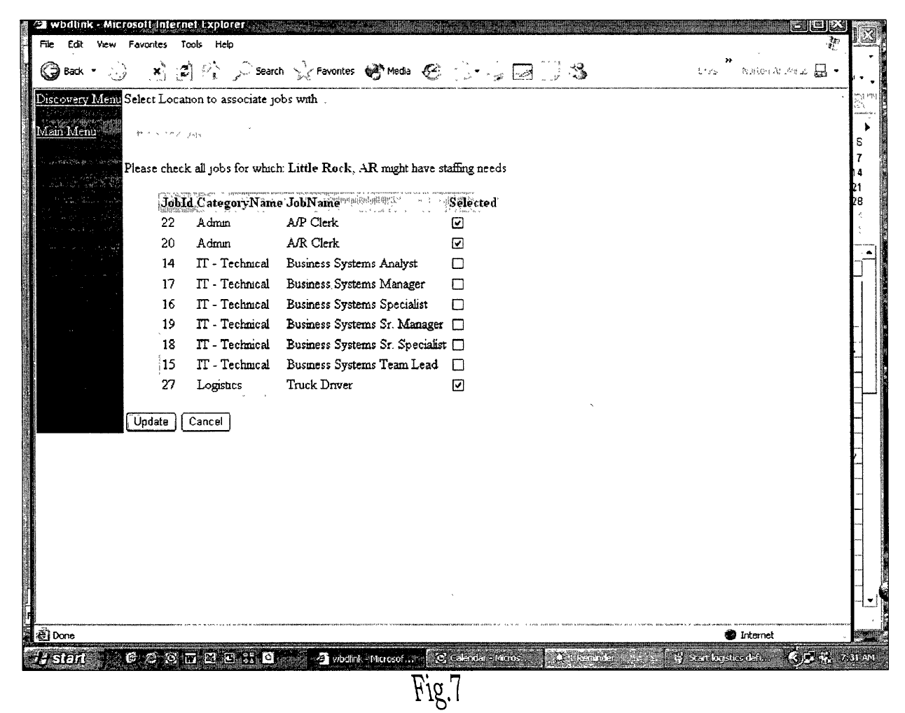

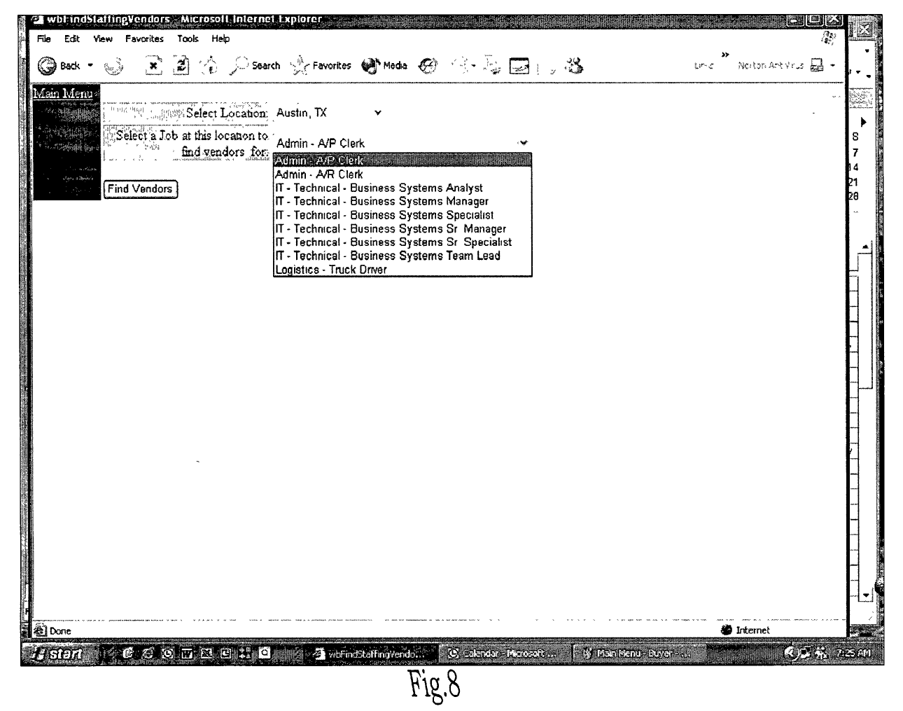

FIG. 6 is a screen shot of a purchase order request interface created by a vendor from a workplace company template. The purchase order request interface has multiple fields to both identify the talent, the staffing vendor, the staffing buyer at the workplace company, the start and stop dates, the hourly bill and pay-rate, job skill description, order type and email address of the talent. This menu will vary depending on the contract in place as described by rules and templates. In some embodiments, the purchase order may look the same for different companies if each selected a standard or default template for purchase orders.

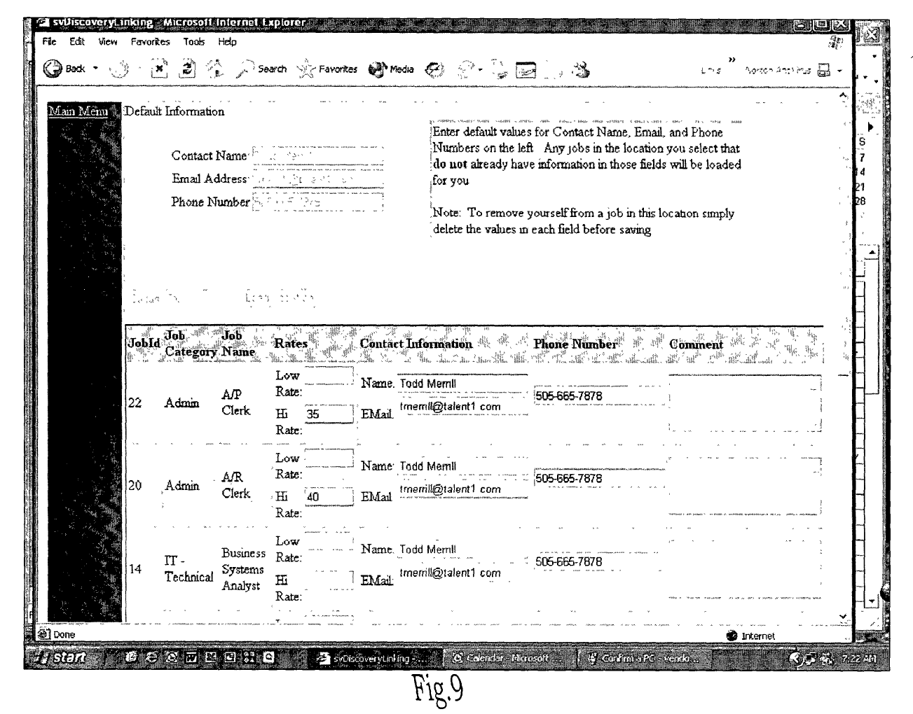

FIG. 7 is a screen shot of a staffing vendor discover interface provided by the server 110. In this version of the screen, the user has requested a check for all job types for which a specified location might have staffing needs. A list of such job types is provided from the database 115 that includes job ID, category name, and job name. Check boxes are provided for selecting the jobs to obtain further information, such as a workplace contact for each job to see if a purchase order should be created.

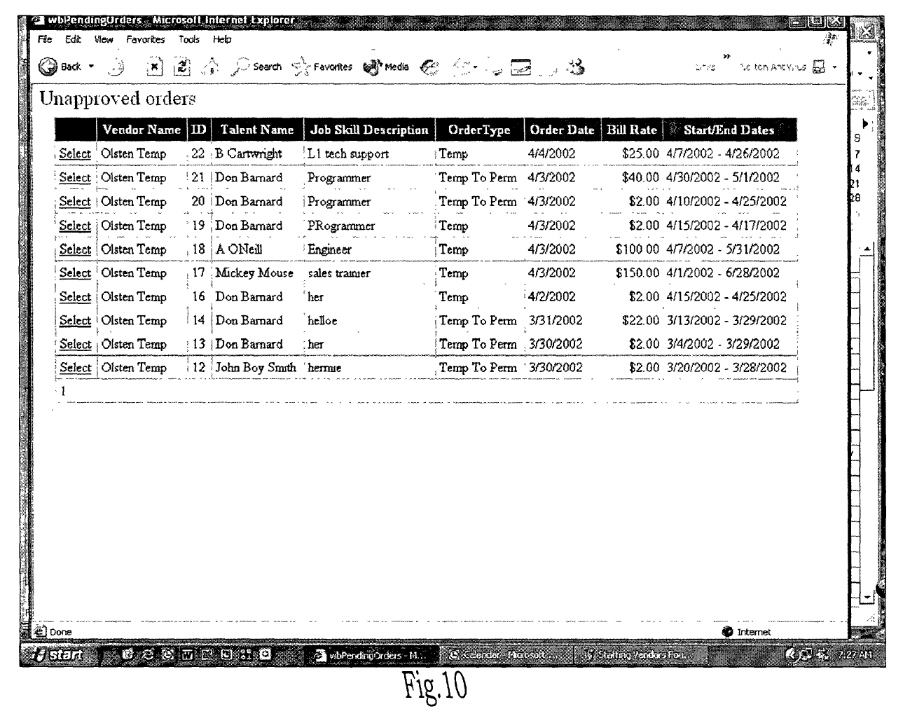

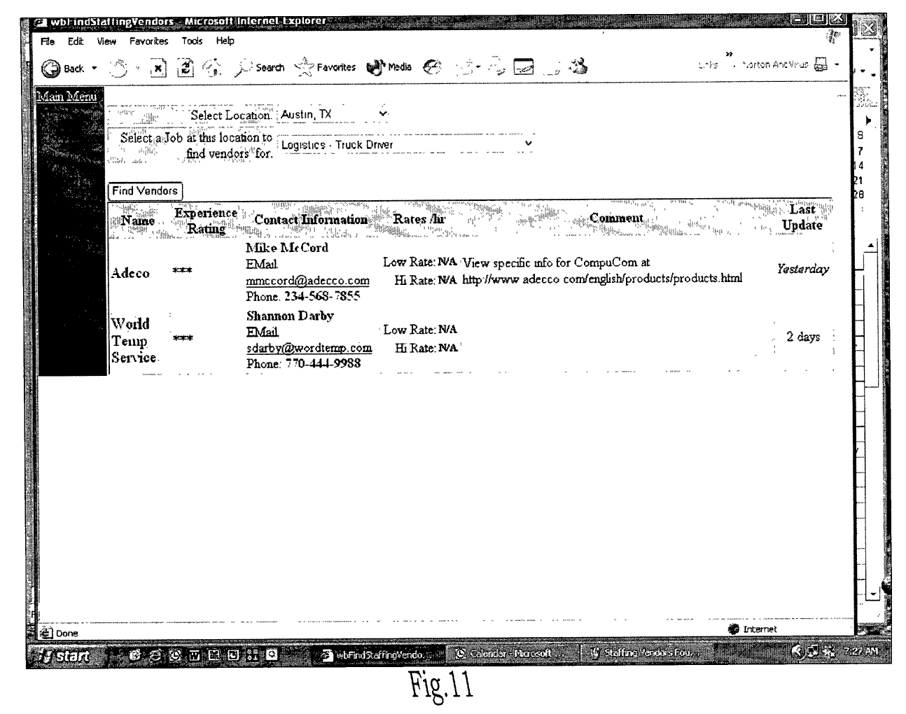

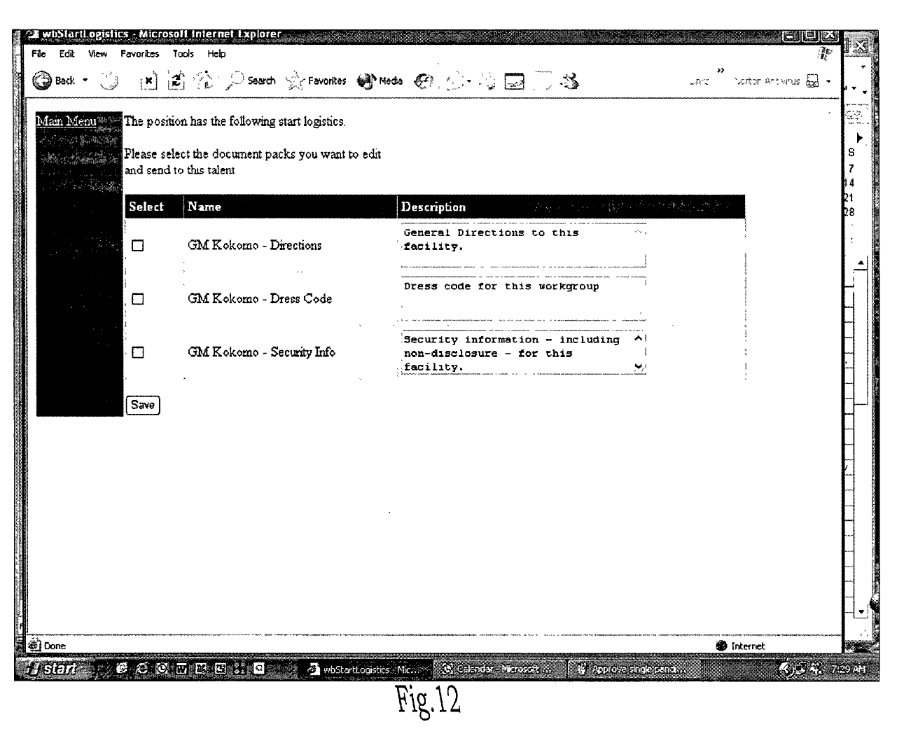

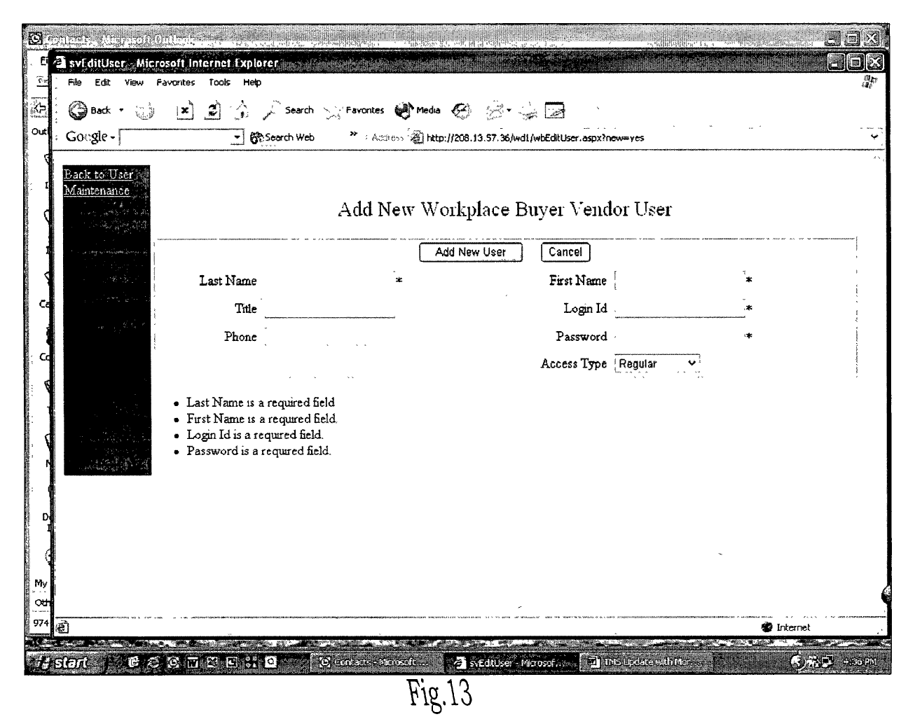

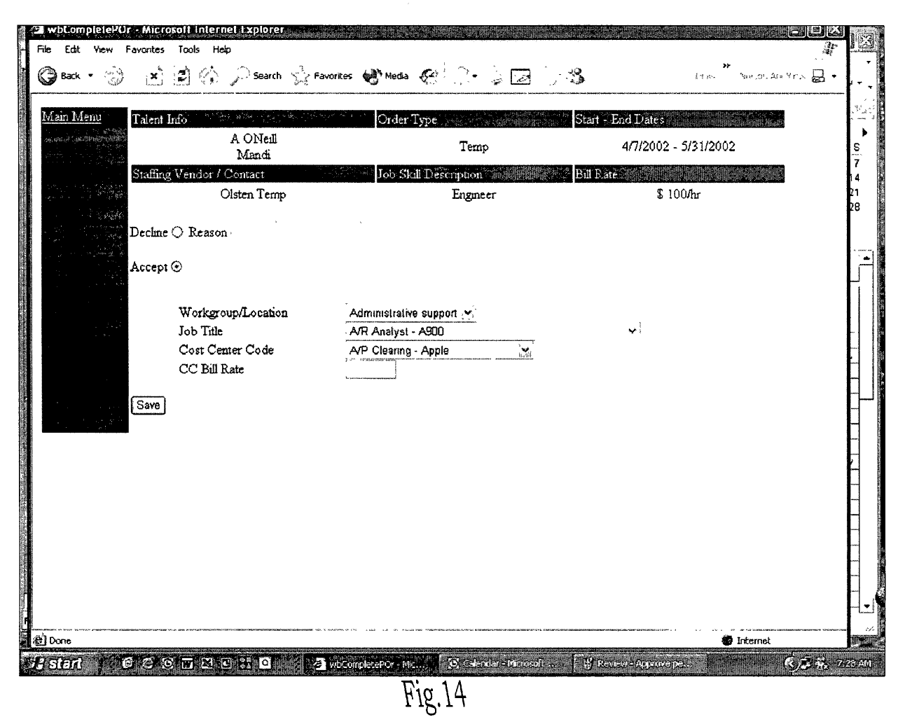

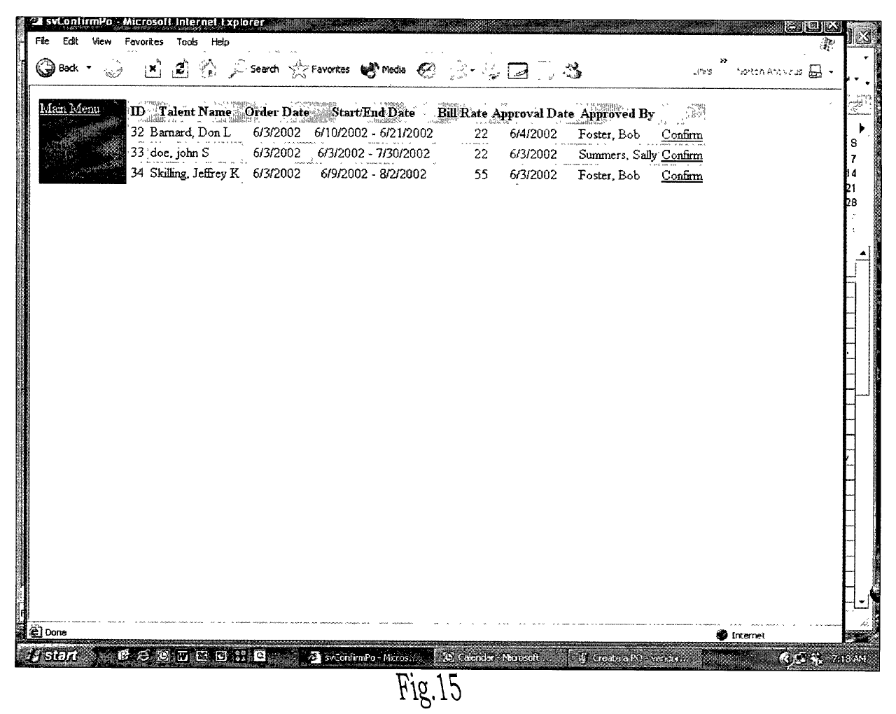

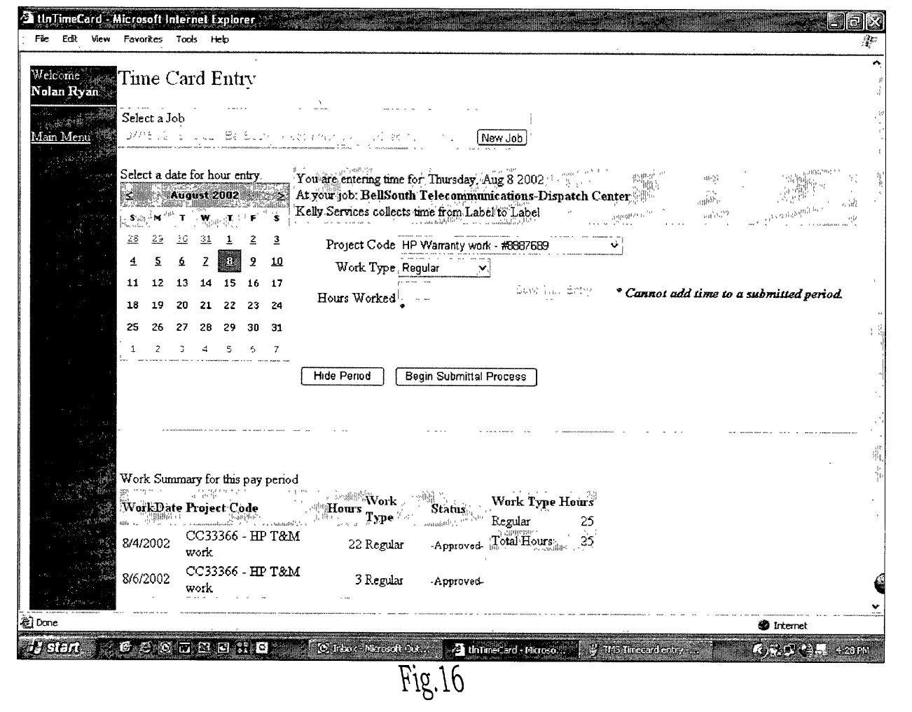

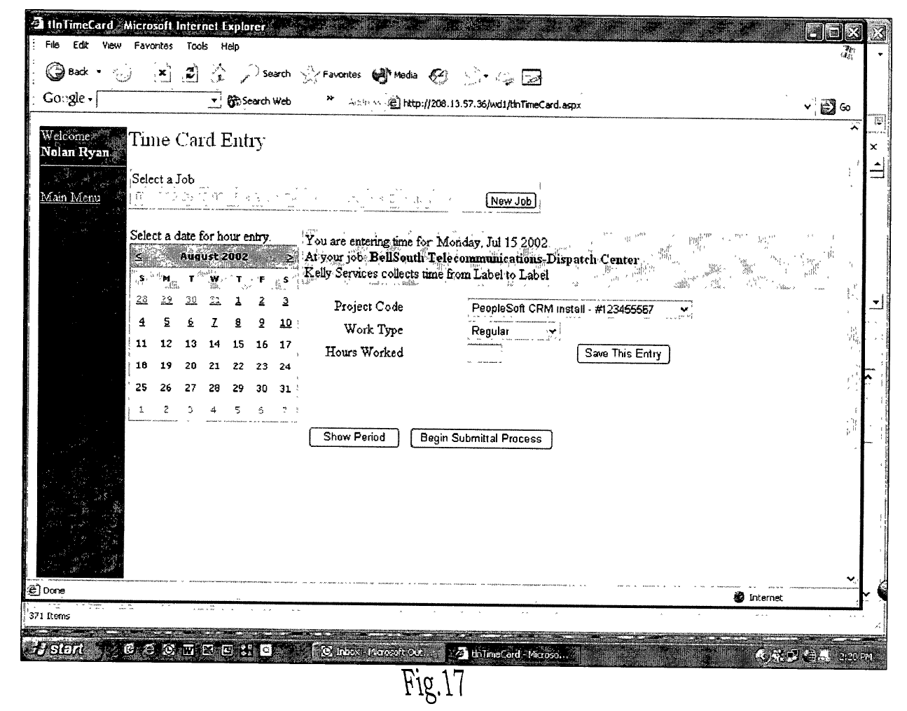

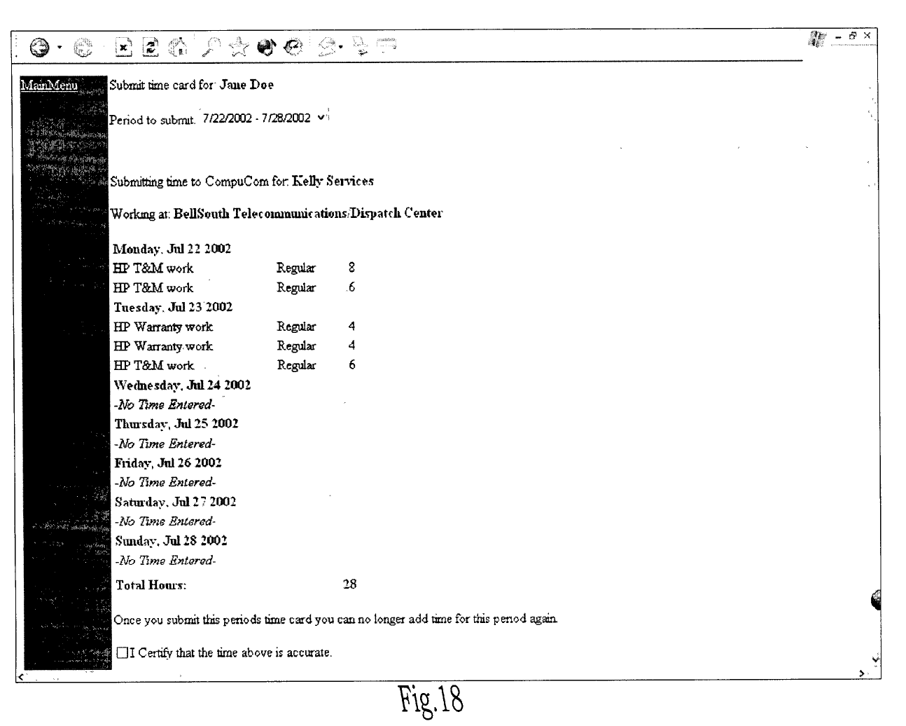

FIG. 8 is a screen shot of a workplace manager interface to find vendors for specific jobs at specific locations. In a company having several different locations, many different local vendors may be used. Further some vendors only provide talent for specific job types. This interface is very useful in identifying vendors that can meet specific needs based on job type and location. As seen in this example, the workplace manager has selected Austin, Tex. as a location, and an Admin—A/P Clerk as the job. The system will return a list of vendors that can provide such a person at such a place.

FIG. 9 illustrates a screen for entering or editing contact information. The fields include job ID, job category, job name, rates (both high and low), name of the contact, phone number and an email address.

FIG. 10 is a screen shot of a list of unapproved purchase orders. A mechanism, such as a hypertext link “Select” is provided to view the unapproved purchase orders in further detail. In this view, the purchase orders are all for one workplace company. The fields include vendor name, ID, talent name, job skill description, order type, order date, bill rate and start/end dates.

FIG. 11 is a screen shot showing vendors found given selection criteria of a location of Austin, Tex., and a job of Logistics—Truck Driver. Several vendors are identified and fields include name, experience rating, contact information, rates, comments, and last update.

FIG. 12 is a screen shot showing information that can be selected by checkbox for sending to talent to assist in performing under the purchase order. A checkbox is provided to select multiple different packets or documents describing things such as directions, dress code and security information. Editing of the documents is also permitted. The documents are then automatically emailed to the talent, or printed for hard copy mailing if desired.

FIG. 13 is a screen shot that allows the addition of a new user to the database 115. The fields in this example include last name, first name, title, user or login id, phone, password and access type. Several different roles are defined for access type, such as talent, workplace manager, staffing vendor, etc. Each role allows a predetermined access to certain fields of the database as shown in screens of information.

FIG. 14 is a screen shot of a workplace manager interface provided by the server for approving purchase orders. The talent and order type are identified, as well as the staffing vendor contact and job description, billing rate, and start stop dates are provided. The workgroup/location, job title, cost center code and CC bill rate are shown in further embodiments for example. The workplace manager is then provided checkboxes to accept or decline, along with a text box for reasons for declining.

FIG. 15 is a screen shot of an interface provided by the talent management system showing approved purchase orders identifying specific talent. The talent name and ID, order date, start and end date, bill rate, approval rate, approved by and a confirm link or button for confirming the purchase order by the vendor are provided on this screen. Once confirmed, talent is notified of the purchase order and given information to perform the requirement.

The talent management system has been described with respect to one workplace company utilizing several vendors. A website in one embodiment is tailored to the workplace company requirements. In further embodiments, different websites are provided for different workplace companies. The different websites may be on different servers, or combined on one server with a single database having appropriate permission controls for accessing vendor data. Further, vendor data may be separately stored for each workplace website.

Once talent begins work, they access the talent management system via a workstation, appliance or other means to submit time cards. A screen for entering time is shown in FIG. 16. A job is selected from a drop down menu, which may list several part time jobs the talent is currently working. A calendar is provided to select a date for hour entry. A display tells the talent when and where they are entering time. Project codes and work types may be selected via a pull down menu. A text box is provided for entering hours worked. The pull down menus are populated from the database in one embodiment.

In FIG. 16, a work summary for the pay period is provided, with a button for hiding the summary. The summary shows work dates, project codes, hours worked, a work type, and the status of the time entries, as well as totals for the entire period. Once time is submitted for a period, no further time can be submitted as indicated by text associated with the asterisk. A button is also provided for beginning the submittal process for submitting a time card for a period.

FIG. 17 is an alternative screen shot of the time card of FIG. 16, with the summary for the period hidden. A button is provided to show the period. Again, a Begin Submittal button is provided which transfers the talent to a submit screen shown in FIG. 18. The submit screen identifies the talent and identifies the period to submit, including a drop down menu to select the period. A detailed list of the date, work, time and type of time are provided, including indications where no time was entered. A total hours is also provided along with a notice the once submitted, no time can be added to the period submitted. Finally, a checkbox is provided for certifying that the time above is accurate.

It should be noted that all of the screens shown may have different selection mechanisms, text and layouts. The screens are just one example of an interface to the talent management system. Many variations are possible without departing from the scope of the invention.

### Conclusion

An Internet based computer system referred to as a talent management system (TMS), facilitates the procurement and administration of temporary staff sourced from multiple vendors all of whom serve as a primary vendor. TMS provides a network based implementation of an improved process that allows workplace managers, with delegated authority, to initiate the procurement of temporary staff from corporate pre-approved suppliers using any one of a familiar manner, such as by calling, emailing or faxing the vendor while still providing centralized corporate management with a means for comprehensive reporting and improved back office processes for this expenditure. The Vendor uses an interface provided by TMS to self-submit for a purchase order based on the workplace firms specific template for a PO. The purchase order is then made available to the field manager, who uses his interface to complete the purchase order request which is then processed for delegate authority, escalated to a supervisor if necessary and then once approved a PO is processed with approval notification delivered to the vendor and talent.

The selected temporary staff loaded in the purchase order by the vendor. The temporary staff is provided an interface for time and expense entry that is then routed to appropriate managers for confirmation. Workplace managers are provided interfaces for documenting the performance of the temporary staff.

The server further tracks the use of temporary staff and facilitates management of the temporary staff by providing reports and automated notices. Such notices include communications regarding the end date of assignments sent a predetermined time ahead of the end date allowing the workplace manager time to determine whether to request an extension of the term.

1. A computer implemented method of managing procurement of temporary talent, the method comprising:
receiving a communication from a workplace manager identifying a need for temporary talent;
creating a purchase order in accordance with the need;
sending the purchase order to the workplace manager for approval; and
completing the procurement of the talent when the purchase order is approved.

2. The method of claim 1 wherein the purchase order specifies start and stop dates.

3. The method of claim 2 and further comprising monitoring the talent start and stop dates.

4. The method of claim 2 wherein the purchase order further specifies the workplace manager, job title, talent name, pay rate and bill rate.

5. A computer implemented method for staffing vendors to manage providing temporary talent to a workplace entity, the method comprising:
receiving a communication from a workplace entity identifying a need for temporary talent;
creating a purchase order in accordance with the need, wherein the purchase order is automatically created based on information about the workplace entity;
sending the purchase order to the workplace entity for approval; and
procuring the talent when the purchase order is approved.

6. The method of claim 5 wherein the purchase order specifies start and stop dates.

7. The method of claim 6 and further comprising monitoring the talent start and stop dates.

8. The method of claim 6 wherein the purchase order further specifies the workplace manager, job title, talent name, pay rate and bill rate.

9. A system for managing procurement and administration of contractors, the system comprising:
a database, the database having templates for creating purchase orders tailored specifically to the workplace;
a server coupled to a network and the database, the server providing multiple interactive views to vendors and a workplace company for creating and approving the purchase orders for contractors.

10. The system of claim 9 wherein the server further comprises a module that receives time entry information from contractors hired pursuant to approved purchase orders.

11. The system of claim 10 wherein the server further comprises a module that creates reports showing the status of contractors hired pursuant to approved purchase orders.

12. The system of claim 9 wherein the database comprises information selected from the group consisting of start and stop dates, workplace manager, job title, talent name, pay rate and bill rate.

13. The system of claim 9 wherein the server further comprises a module that automatically provides predetermined notices to workplace managers regarding contractors.

14. They system of claim 13 wherein such predetermined notices comprise information describing a stop date for a contractor sent a predetermined time prior to the stop date.

15. The system of claim 9 wherein the database further comprises rules defining a process for approving the purchase orders.

16. The system of claim 9 wherein the database further comprises a list of contractors for selection by vendors in creating purchase orders.

17. A system for managing temporary staff procurement and utilization, the system comprising:
a database containing information related to multiple staffing vendors, a company utilizing temporary staff, and temporary staff;
means utilized by a staffing vendor for entering purchase orders from requests by a company representative;
means for sending the purchase order to the company representative for approval; and
means for monitoring temporary staff selected to fulfill the purchase order.

18. The system of claim 17 wherein the means for entering purchase orders comprises a purchase order template tailored to the company.

19. The system of claim 17 wherein the means for sending the purchase order comprises the Internet.

20. A system for managing temporary talent, the system comprising:
a database containing information related to multiple staffing vendors, companies utilizing temporary talent, and temporary talent;
means utilized by a talent vendor for entering purchase orders from requests by a company representative;
means for sending the purchase order to the company representative for approval; and
means for monitoring temporary talent selected to fulfill the purchase order.

21. A network facilitated method of procuring talent from a vendor for working at a workplace, the method comprising:
providing a purchase order template tailored to the workplace to multiple vendors;
transferring completed purchase orders from a vendor to the workplace for approval; and
transferring approved purchase orders back to the vendor for fulfillment.

22. The method of claim 21 wherein the purchase order template is provided at a workplace specific Internet web site.

23. The method of claim 22 wherein the workplace specific web site provides an approval process for the purchase orders.

24. The method of claim 23 wherein checkboxes are utilized to accept or reject purchase orders.

25. A computer readable medium having instructions for causing a computer to perform a method of procuring talent from a vendor for working at a workplace, the method comprising:
providing a purchase order template tailored to the workplace to multiple vendors;
transferring completed purchase orders from a vendor to the workplace for approval; and
transferring approved purchase orders back to the vendor for fulfillment.
